(19) United States
(12) Patent Application Publication
(10) Pub. No.: US 2007/0080648 A1
(43) Pub. Date: Apr. 12, 2007

(54) DRIVING METHOD OF COLD CATHODE FLUORESCENT FLAT LAMP

(75) Inventors: Yui-Shin Fran, Hsinchu City (TW); Lai-Cheng Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: DELTA OPTOELECTRONICS, INC., Hsin-Chu (TW)

(21) Appl. No.: 11/608,845

(22) Filed: Dec. 11, 2006

Related U.S. Application Data
(62) Division of application No. 10/709,989, filed on Jun. 11, 2004.

(30) Foreign Application Priority Data
Apr. 7, 2004 (TW) 93109561

(51) Int. Cl. G09G 3/10

(52) U.S. Cl. 315/169.3

(57) ABSTRACT

A driving method of a cold cathode fluorescent flat lamp (CCFFL) for improving the light emitting uniformity of the cold cathode fluorescent flat lamp (CCFFL) is provided. First, a plurality of first light emitting areas and a plurality of second light emitting areas are generated alternately by the cold cathode fluorescent flat lamp (CCFFL). It is noted that the first light emitting areas and the second light emitting areas are not completely overlapped, and a frequency of alternately generating the first light emitting areas and the second light emitting areas is higher than a range that can be viewed as separate elements by unaided human eye.

### CROSS-REFERENCE TO RELATED APPLICATION

This is a divisional application of U.S. patent application Ser. No. 10/709,989, filed on Jun. 11, 2004, which claims the priority benefit of Taiwan patent application serial no. 93109561, filed on Apr. 7, 2004 and is now pending. The entirety of each of the above-mentioned patent applications is hereby incorporated by reference herein and made a part of this specification.

### BACKGROUND OF THE INVENTION

1. Field of the Invention

The present invention generally relates to a driving method of a cold cathode fluorescent flat lamp (CCFFL). More particularly, the present invention relates to a driving method of a cold cathode fluorescent flat lamp (CCFFL) having larger and uniform light emitting area.

2. Description of Related Art

Recently, as the development of electronic technology advances, the electronic devices such as mobile phone, digital camera, digital video camera, notebook or desktop computer are developed to be more convenient, multi-functional and beautiful in shape. Especially, the display device of mobile phone, digital camera, digital video camera, notebook or desktop computer is an indispensable and important interface for the communication between the device and the user, and has been improved to be more convenient and multi-functional. Recently, liquid crystal display panel (LCD panel) has become the major trend of the display device of the electronic devices described above. However, since the liquid crystal display panel is not self-illuminant, a backlight module should be adopted under the LCD panel as a light source.

In general, a conventional backlight module includes a lamp tube, a reflector holder and a light guide plate (LGP). The light guide plate can transform the linear light source emitted by the lamp tube into a surface light source. Conventionally, the lamp tube is disposed on one side of the light guide plate, thus the uniformity of the surface light source transformed by the light guide plate is not well developed. Therefore, a plurality of optical films of layers, such as, diffuse films or light enhancement films or layers, is disposed on the light exit plane of the light guide plate. However, since the light guide plate and optical film or layer is expensive, the cost of the backlight module is increased. In addition, since the lamp tube, the reflector holder and the light guide plate are isolated components, a glue trim is required to load and mount the lamp tube, the reflector holder and the light guide plate. In summary, the fabrication of the conventional backlight module is complex, and the cost of the fabrication is high.

Therefore, a cold cathode fluorescent flat lamp (CCFFL) is developed recently. In general, the cold cathode fluorescent flat lamp (CCFFL) has a better luminous efficiency and uniformity than the conventional light source generated by the lamp tube, and may be provide as a large area surface light source. Therefore, the cold cathode fluorescent flat lamp (CCFFL) has been broadly used in the backlight module of the liquid crystal display panel and in other application.

It is noted that, the cold cathode fluorescent flat lamp (CCFFL) is a plasma light emitting component, wherein the plasma is formed by the ionized gas generated by the collision of the inert gas with the electrons emitted by the cathode of a cavity. Thereafter, ultraviolet light is emitted by the transition of the excited gas atoms of the plasma from the excited state to the ground state. Then, the emitted ultraviolet light further excites the fluorescence material coated on the inside wall of the cavity to generate visible light.

Recently, the driving method of the cold cathode fluorescent flat lamp (CCFFL) is generally performed by controllable local discharge method. For example, a plurality of protrusions is disposed on the electrode to generate point discharge on the protrusions of the electrode. Therefore, a large area of cold cathode fluorescent flat lamp (CCFFL) is constructed by, for example, a variety of point lamps.

However, in the local discharge method, the light intensity of the cold cathode fluorescent flat lamp (CCFFL) is not uniform. For example, the light intensity near the protrusions is larger than that away from the protrusions, and thus a regular pattern of light source having alternative bright and dark areas is generated. Thus the whole light emitting uniformity of the cold cathode fluorescent flat lamp (CCFFL) is reduced.

### SUMMARY OF THE INVENTION

Therefore, the present invention is directed to a cold cathode fluorescent flat lamp (CCFFL) to increase the light emitting uniformity.

In addition, the present invention is directed to a method of driving a cold cathode fluorescent flat lamp (CCFFL) to increase the light emitting uniformity of the cold cathode fluorescent flat lamp (CCFFL).

Moreover, the present invention is directed to a cold cathode fluorescent flat lamp (CCFFL) having a larger discharge area between the electrodes. Thus, the light emitting area of the cold cathode fluorescent flat lamp (CCFFL) is also increased, and the whole light emitting uniformity of the cold cathode fluorescent flat lamp (CCFFL) is increased.

The present invention provides a cold cathode fluorescent flat lamp (CCFFL) comprising, for example but not limited to, a cavity, a fluorescence material, a discharge gas, at least one first electrode pairs and at least one second electrode pair. The cavity comprises, for example but not limited to, a first inner wall and a second inner wall opposite to the first inner wall or disposed on an outer wall of the cavity. The fluorescence material is disposed over the inner wall of the cavity, wherein the inner wall comprises the first inner wall and/or the second inner wall. The discharge gas is disposed inside the cavity. The first electrode pair is disposed over the first inner wall, or may be disposed over the outer wall of the cavity, and each of first electrode pairs comprises a first anode and a first cathode, wherein a first light emitting area is generated between the first anode and the first cathode. The second electrode pair is disposed over the second inner wall, or may be disposed over the outer wall of the cavity, and each of second electrode pair comprises a second anode and a second cathode, wherein a second light emitting area is generated between the second anode and the second cathode.

In one embodiment of the present invention, the cavity comprises a first substrate, a second substrate and a side bar. The second substrate is disposed over the first substrate, and the side bar is disposed between the first substrate and the second substrate and connected to an edge of the first substrate and an edge of the second substrate.

In one embodiment of the present invention, a portion of the first light emitting areas is not overlapped with the second light emitting areas, or a portion of the second light emitting areas is not overlapped with the first light emitting areas. In another embodiment of the invention, all of the first light emitting areas are not completely overlapped with all of the second light emitting areas.

In one embodiment of the present invention, the first anodes and the first cathodes over the first inner wall are arranged in a sequence in the order of anode, cathode, cathode and anode. In another embodiment of the invention, the second anodes and the second cathodes over the second inner wall are arranged in a sequence of anode, cathode, cathode and anode.

In one embodiment of the present invention, each of the first anodes, each of the first cathodes, each of the second anodes or each of the second cathodes comprises a plurality of protrusions.

In addition, the present invention provides a driving method of a cold cathode fluorescent flat lamp (CCFFL) for improving the light emitting uniformity of the cold cathode fluorescent flat lamp (CCFFL). The method comprises, for example but not limited to, the following steps. First, a plurality of first light emitting areas and a plurality of second light emitting areas are generated alternately by the cold cathode fluorescent flat lamp (CCFFL). It is noted that the first light emitting areas and the second light emitting areas are not completely overlapped, and a frequency of alternately generating the first light emitting areas and the second light emitting areas is higher than a range that can be viewed as separate elements by unaided human eye.

In one embodiment of the present invention, the frequency of alternately generating the first light emitting areas and the second light emitting areas comprises 16 Hz.

In addition, the present invention provides a driving method of a cold cathode fluorescent flat lamp (CCFFL) for improving the light emitting uniformity of the cold cathode fluorescent flat lamp (CCFFL). The method comprises, for example but not limited to, the following steps. First, a plurality of first light emitting areas and a plurality of second light emitting areas are generated alternately by the cold cathode fluorescent flat lamp (CCFFL). It is noted that, a portion of the first light emitting areas is not overlapped with the second light emitting areas, or a portion of the second light emitting areas is not overlapped with the first light emitting areas. In addition, a frequency of alternately generating the first light emitting areas and the second light emitting areas is higher than a range that can be viewed as separate elements by unaided human eye.

In one embodiment of the present invention, the frequency of alternately generating the first light emitting areas and the second light emitting areas comprises 16 Hz.

Furthermore, the present invention provides a cold cathode fluorescent flat lamp (CCFFL) comprising, for example but not limited to, a cavity, a discharge gas, a fluorescence material and at least one electrode pair. The discharge gas is disposed inside the cavity, the fluorescence material is disposed over the inner wall of the cavity. The electrode pair is disposed over the inner wall of the cavity, or may be disposed over the outer wall of the cavity. It is noted that each of the electrode pairs comprises a plurality of first protrusions and a plurality of second protrusions disposed opposite to the first protrusions, wherein the first protrusions and the second protrusions are not aligned.

In one embodiment of the present invention, the first protrusions and the second protrusions are arranged in equal distance, and an interval of the first protrusions and an interval of the second protrusions are equal.

In one embodiment of the present invention, each the first protrusions is aligned with a midpoint of two of the second protrusions adjacent thereof.

In one embodiment of the present invention, the cavity comprises, for example, a first substrate, a second substrate and a side bar. The second substrate is disposed over the first substrate, and the side bar is disposed between the first substrate and the second substrate and connected to an edge of the first substrate and an edge of the second substrate.

Accordingly, a plurality of non-aligned light emitting areas is disposed in the cold cathode fluorescent flat lamp (CCFFL) of the present invention, and the light emitting areas are alternately driven rapidly. Therefore, the cold cathode fluorescent flat lamp (CCFFL) may be provided as a large area surface light source due to the persistent vision of human eye. Thus, the pattern of the light source having a variety of bright and dark areas generated in the conventional driving method of the cold cathode fluorescent flat lamp (CCFFL) due to local discharge is reduced.

In addition, a plurality of protrusions may be disposed over the electrodes of the cold cathode fluorescent flat lamp (CCFFL) of the present invention. In the present invention, each protrusion of one electrode will discharge to the other two corresponding adjacent protrusions on the electrodes of the same electrode pair respectively. Therefore, the discharge area between the electrodes of the cold cathode fluorescent flat lamp (CCFFL) of the present invention is larger than that of the conventional cold cathode fluorescent flat lamp (CCFFL). Therefore, each electrode pair of the cold cathode fluorescent flat lamp (CCFFL) of the present invention has a larger light emitting area than that of the conventional ones. Therefore, the whole light emitting uniformity of the cold cathode fluorescent flat lamp (CCFFL) of the invention is increased.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a cross-sectional view illustrates a cold cathode fluorescent flat lamp (CCFFL) according to one embodiment of the present invention.

FIG. 2 is a cross-sectional view illustrates a cold cathode fluorescent flat lamp (CCFFL) according to one embodiment of the present invention.

FIG. 3 is a cross-sectional view illustrating an electrode pair of a cold cathode fluorescent flat lamp (CCFFL) according to one embodiment of the present invention.

### DESCRIPTION OF THE EMBODIMENTS

The present invention now will be described more fully hereinafter with reference to the accompanying drawings, in which preferred embodiments of the invention are shown. This invention may, however, be embodied in many different forms and should not be construed? as limited to the embodiments set forth herein; rather, these embodiments are provided so that this disclosure will be thorough and complete, and will fully convey the scope of the invention to those skilled in the art. Like numbers refer to like elements throughout.

The present invention is related to placement of electrodes of the cold cathode fluorescent flat lamp (CCFFL) and the method of arrangement thereof. In addition, the present invention is related to a driving method of the cold cathode fluorescent flat lamp (CCFFL) to enhance the light emitting uniformity of the cold cathode fluorescent flat lamp (CCFFL). Hereinafter, a variety of embodiments will be provided to describe the driving method of the cold cathode fluorescent flat lamp (CCFFL) of the present invention and the dispose position and the arrangements of the electrodes of the cold cathode fluorescent flat lamp (CCFFL). However, the embodiments are only illustrated a examples and can not be used to limit the scope of the present invention.

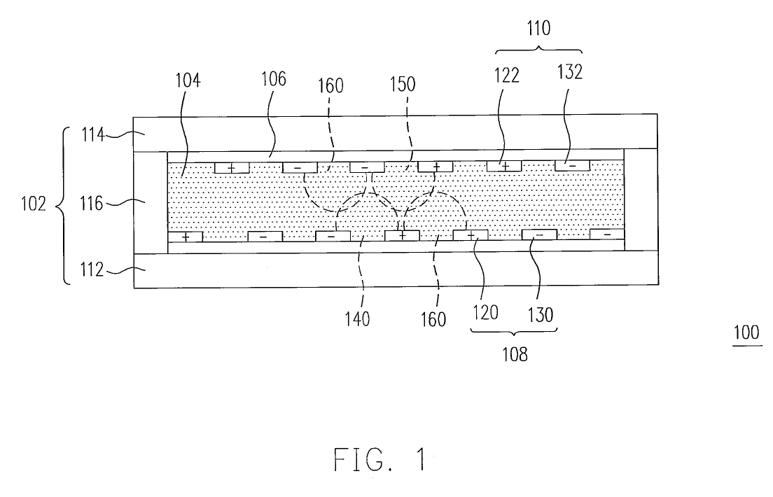

FIG. 1 is a cross-sectional view illustrating a cold cathode fluorescent flat lamp (CCFFL) according to one embodiment of the present invention, wherein the “+” and “−” shown in FIG. 1 represent the polarity of the electrodes, for example, “+” represents an anode and “−” represent a cathode.

Referring to FIG. 1, the cold cathode fluorescent flat lamp (CCFFL) 100 comprises, for example but not limited to, a cavity 102, a discharge gas 104, a fluorescence material 106, first electrode pairs 108 and second electrode pairs 110. The cavity 102 comprises a first inner wall and a second inner wall opposite to the first inner wall. In the present embodiment, the cavity 102 comprises, for example but not limited to, a first substrate 112, a second substrate 114 disposed over the first substrate 112 and a side bar 116 connected to an edge of the first substrate 112 and an edge of the second substrate 114. Therefore, in the present embodiment, the first inner wall may be the first substrate 112, and the second inner wall may be the second substrate 114.

The fluorescence material 106 is disposed over the inner wall of the cavity 102, for example but not limited to, disposed over the first substrate 112 and/or the second substrate 114. The discharge gas 104 is disposed inside the cavity 102 and comprises, for example but not limited to, inert gas such as xenon (Xe), neon (Ne) or argon (Ar) or the mixing thereof.

The first electrode pairs 108 is disposed over the first inner wall of the cavity 102, for example but not limited to, over the first substrate 112. For example, each of first electrode pairs 108 comprises a first anode 120 (as the “+⇄ shown in FIG. 1) and a first cathode 130 (as the “−” shown in FIG. 1). In one embodiment of the invention, the first anodes 120 and the second cathodes 130 are arranged in a sequence in the order of anode, cathode, cathode and anode over the first substrate 112 as shown in FIG. 1. The second electrode pair 110 is disposed over the second inner wall of the cavity 102, for example but not limited to, over the second substrate 114. Each second electrode pair 110 may comprise a second anode 122 and a second cathode 132. In one embodiment of the invention, a sequence of arranging the second anodes 122 and the second cathodes 132 over the second substrate 114 is similar or identical to a sequence of arranging the first anodes 120 and second cathodes 130 over the first substrate 112 described above.

The light emitting mechanism of the cold cathode fluorescent flat lamp (CCFFL) 100 of the invention is driven by discharging the electrodes. In one embodiment of the present invention, the light emitting mechanism generates a first light emitting area 140 between the first anode 120 and the first cathode 130 of each first electrode pair 108, and generates a second light emitting area 150 between the second anode 122 and the second cathode 132 of each second electrode pair 110 as shown in FIG. 1. However, the range of the first light emitting area 140 and the range of the second light emitting area 150 shown in FIG. 1 are only illustrated for describing the position thereof. It is noted that, the actual range of the first light emitting area 140 and the actual range of the second light emitting area 150 are dependent on the operational parameters of the cold cathode fluorescent flat lamp (CCFFL) 100, for example, the number of excited atoms of the discharge gas 104 and can not be limited by FIG. 1.

In one embodiment of the invention, a portion of the first light emitting areas 140 is not overlapped with the second light emitting areas 150, or a portion of the second light emitting areas 150 is not overlapped with the first light emitting areas 140. Therefore, the non-illuminating area 160 disposed between the first electrode pair 108 and the second electrode pair 110 may be compensated.

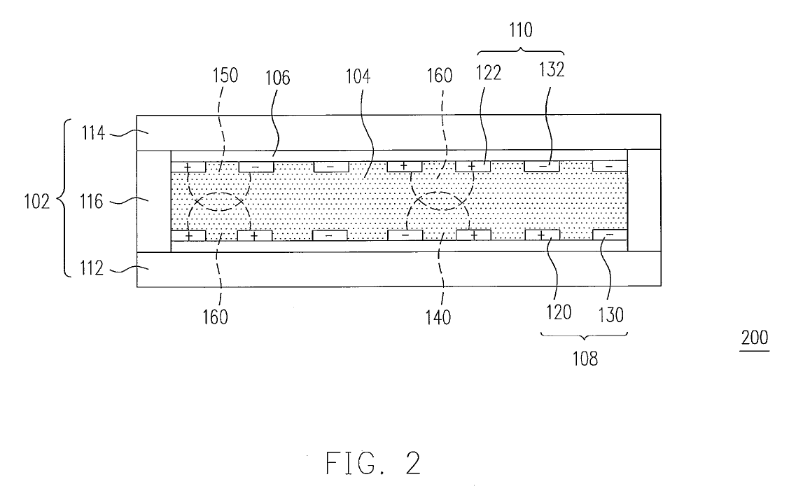

In addition, in another embodiment of the present invention, the first light emitting areas 140 and the second light emitting areas 150 are not completely overlapped. FIG. 2 is a cross-sectional view illustrating a cold cathode fluorescent flat lamp (CCFFL) according to one embodiment of the present invention. In comparison with FIG. 1, the position for disposing the electrodes shown in FIG. 2 is different. Besides, other components of FIG. 2 having the same reference numbers shown in FIG. 1 comprises the same or similar material, dispose position and construction of FIG. 1 and will not be described hereinafter.

Referring to FIG. 2, the first light emitting area 140 and the second light emitting area 150 of the cold cathode fluorescent flat lamp (CCFFL) 200 are alternately arranged over the cavity 102. Therefore, the first light emitting area 140 can completely compensate the non-illuminating area 160 between the second electrode pairs 110, and the second light emitting area 150 can completely compensate the non-illuminating area 160 between the first electrode pairs 108.

In order to make the first light emitting area 140 and the second light emitting area 150 of the two embodiments described above being complementary, the present invention provides a driving method of the cold cathode fluorescent flat lamp (CCFFL). Next, referring to FIG. 1 and FIG. 2, in the driving method, the first electrode pair 108 and the second electrode pair 110 are alternately driven. Therefore, the first electrode pair 108 and the second electrode pair 110 are alternately discharged in a frequency. Therefore, a first light emitting area 140 and a second light emitting area 150 of the cold cathode fluorescent flat lamp (CCFFL) 100 or 200 are generated alternately. In one embodiment of the invention, in the driving method, for example but not limited to, a voltage having waveform of sine wave or pulse wave is provided for driving the first electrode pair 108 and the second electrode pair 110.

It is noted that, the frequency of the alternately discharging of the first electrode pair 108 and the second electrode pair 110 should be higher than a frequency range that can be viewed as separate elements by unaided human eye, to generate a persistent vision in the eye. In addition, since the first light emitting area 140 and the second light emitting area 150 are not totally overlapped, the non-illuminating area 160 may be mutually compensated, therefore, the non-illuminating area 160 can not be viewed as separate elements by the unaided human eye. Therefore, the pattern of the light source having a variety of bright and dark areas generated in the conventional cold cathode fluorescent flat lamp (CCFFL) and the driving method thereof can be reduced. In one embodiment of the present embodiment, the frequency of alternately discharging the first electrode pair 108 and the second electrode pair 110 is, for example but not limited to, equal to or larger than 16 Hz.

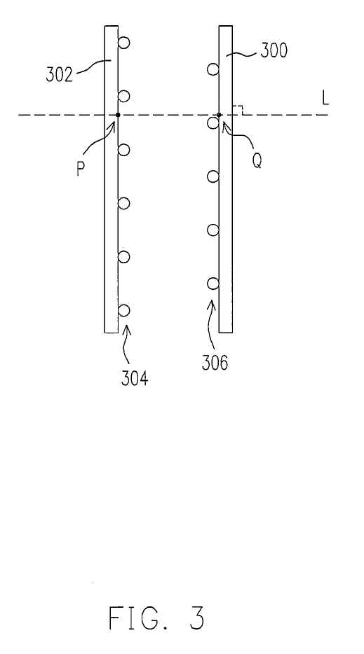

In another embodiment of the present invention, the electrodes of the cold cathode fluorescent flat lamp (CCFFL) comprises a plurality of protrusions. FIG. 3 is a cross-sectional view illustrating an electrode pair of a cold cathode fluorescent flat lamp (CCFFL) according to one embodiment of the present invention. Referring to FIG. 3, the set electrode pair comprises a cathode 300 and an anode 302. The anode 302 comprises, for example but not limited to, a plurality of first protrusions 304, and the cathode 300 comprises a plurality of second protrusions 306 opposite to the first protrusions 304.

Referring to FIG. 3, the first protrusions 304 and the second protrusions 306 are arranged in equal distance, and an interval of the first protrusion 304 and an interval of the second protrusion 306 are equal. In one embodiment of the invention, each first protrusion 304 is not aligned with the second protrusions 306. In another embodiment of the invention, each first protrusion 304 is aligned at the midpoint of two adjacent second protrusions 306 respectively.

It is noted that, the “aligned” described above means that when a connection line L of a point P of the anode 302 and a point Q of the cathode 300 is perpendicular to an extension of the cathode 300 or an extension of the anode 302, it is said that the point P is aligned to the point Q, or the point Q is aligned to the point P.

After the electrode pairs are driven, the anode 302 and the cathode 300 will discharge between the first protrusions 304 and the second protrusions 306. It is noted that, each first protrusion 304 will discharge to the corresponding two adjacent second protrusions 306, and thus the light emitting area between the electrode pairs are increased. Therefore, the light emitting uniformity of the cold cathode fluorescent flat lamp (CCFFL) is increased.

Accordingly, a plurality of non-aligned light emitting areas is disposed in the cold cathode fluorescent flat lamp (CCFFL) of the present invention, and the light emitting areas are alternately driven rapidly. Therefore, the cold cathode fluorescent flat lamp (CCFFL) may be provided as a large area surface light source due to the persistent vision of human eye. Thus, the pattern of the light source having a variety of bright and dark areas generated in the conventional driving method of the cold cathode fluorescent flat lamp (CCFFL) due to local discharge is effectively reduced.

In addition, a plurality of protrusions may be disposed over the electrodes of the cold cathode fluorescent flat lamp (CCFFL) of the present invention. In the present invention, each protrusion of one electrode will discharge to the other two corresponding adjacent protrusions on the electrodes of the same electrode pair respectively. Therefore, the discharge area between the electrodes of the cold cathode fluorescent flat lamp (CCFFL) is larger than that of the conventional cold cathode fluorescent flat lamp (CCFFL). Therefore, each electrode pair of the cold cathode fluorescent flat lamp (CCFFL), according to an embodiment of the present invention, has a larger light emitting area than that of the conventional ones. Therefore, the whole light emitting uniformity of the cold cathode fluorescent flat lamp (CCFFL) of the invention is increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving method of a cold cathode fluorescent flat lamp (CCFFL), comprising:
alternately generating a plurality of first light emitting areas and a plurality of second light emitting areas, wherein the first light emitting areas and the second light emitting areas are not completely overlapped, and a frequency of alternately generating the first light emitting areas and the second light emitting areas is higher than a range that can be viewed as separate elements by unaided human eye.

2. The driving method of claim 1, wherein the frequency of alternately generating the first light emitting areas and the second light emitting areas comprises 16 Hz.

3. A driving method of a cold cathode fluorescent flat lamp (CCFFL), comprising:
alternately generating a plurality of first light emitting areas and a plurality of second light emitting areas, wherein a portion of the first light emitting areas is not overlapped with the second light emitting areas, or a portion of the second light emitting areas is not overlapped with the first light emitting areas, and a frequency of alternately generating the first light emitting areas and the second light emitting areas is higher than a range that can be viewed as separate elements by unaided human eye.

4. The driving method of claim 3, wherein the frequency of alternately generating the first light emitting areas and the second light emitting areas comprises 16 Hz.
